(19) United States
(12) Patent Application Publication
(10) Pub. No.: US 2012/0130292 A1
(43) Pub. Date: May 24, 2012

(54) MASSAGE DEVICE

(76) Inventor: David Benjoar, Besancon (FR)

(21) Appl. No.: 13/388,541

(22) PCT Filed: Aug. 11, 2010
(86) PCT No.: PCT/FR10/00569

§ 371 Date: Feb. 2, 2012

(30) Foreign Application Priority Data
Aug. 14, 2009 (FR) 0903978

(51) Int. Cl. A61H 7/00

(52) U.S. Cl. 601/136

(57) ABSTRACT

A device for a human leg, includes a one-piece frame made of an at least partially deformable material, having a supporting portion arranged so as to at least partially surround a foot over the length thereof and a generally elongate actuating portion extending substantially perpendicular to the supporting portion and connected to the latter by an intermediate portion, the actuating part including a contact area shaped so as to conform to the human leg and having a defined length in order to be supported on a selected portion of the leg located between the bottom of the Achilles tendon and the bottom of the thigh, so as to provide a self-massaging effect during a walking movement of the human leg.

The present invention relates to a massage device, particularly for a rear part of a human leg.

Massage nowadays has numerous applications. In general terms, massage acts particularly on the skin, muscles, tendons and/or ligaments.

In a more therapeutic field, massage may be used to act either directly or indirectly on blood flow and/or the lymphatic system. In this case the term massotherapy is generally used.

There are other disciplines that refer to massage by different terminology such as “modelling”, for example.

The practice of acting on the blood flow and/or the lymphatic system may be intended in particular to produce lymphatic drainage.

By lymphatic drainage is generally meant massage that helps to stimulate lymph. This highly specialised massage is carried out in particular by kinesiotherapist masseurs. In fact, it requires special training owing to the complexity of the massage movements that have to be carried out.

Lymphatic drainage generally comprises at least two steps, namely:
a first step of stimulating highly vascularised zones where the lymphatic networks are located,
and a second step that aims to expel lymph by pressure manoeuvres applied by the hands of the kinesiotherapist masseur (applying pressure and moving the hands along in particular).

For all these reasons, lymphatic drainage is nowadays mainly carried out manually (MLD: Manual Lymphatic Drainage).

This is particularly problematic for the regular treatment of people suffering from lymphoedema or the syndrome known as “heavy legs”. In fact, in the example of heavy legs syndrome, it is desirable to monitor the patient continuously throughout the day. This is very difficult to achieve with MLD.

Nowadays, automatic devices are known for promoting blood, lymph and energy circulation by the application of pressure/vacuum to parts of the human body.

The document FR 2840198 describes a device powered by electric batteries and comprising a pump to act as the pressure/vacuum means. The pump acts on the veins to stimulate lymphatic blood circulation. The device can be pulled on like a slipper to apply a treatment to the foot for 10 to 30 minutes at variable pressures.

The document WO 98/09596 describes a medical device for increasing the vascular flow rate by the application of a pressure force on parts of the foot, ankle and/or calf. The device is designed to apply continuous pressure mainly by means of a fluid contained in a pouch of the device.

The document WO 97/18788 describes a device that applies cyclic pressure to the outer surface of the leg. The device comprises a number of air chambers.

In general, the prior art devices are too bulky for continuous use on a daily basis. In particular, they cannot be worn in a conventional walking shoe.

The present invention sets out to remedy the situation.

To this end, the invention proposes a massage device for a human leg, which comprises a one-piece frame made of an at least partially deformable material, having a supporting portion arranged so as to at least partially surround a foot over the length thereof and a generally elongate actuating portion extending substantially perpendicular to said supporting portion and connected to the latter by an intermediate portion, the actuating portion including a contact zone shaped so as to conform to the human leg and having a defined length in order to be supported on a selected portion of the leg located between the bottom of the Achilles tendon and the bottom of the thigh, so as to provide a self-massaging effect during a walking movement of the human leg.

According to one embodiment, the supporting portion and the actuating portion are arranged so as to cooperate, forming a lever for the contact zone during said walking movement of the human leg.

According to another embodiment the supporting portion comprises an anchoring portion having fixing means arranged to be fixed to the inside of a shoe.

According to one embodiment, the supporting portion comprises a lower portion arranged to pass underneath the plantar arch in front of the heel of the foot and a recess intended to accommodate the heel of the foot.

According to one embodiment, the intermediate portion comprises an outer intermediate portion shaped so as to conform substantially to the foot at the long fibular muscle (fibularis longus muscle) and an inner intermediate portion shaped to conform substantially to the foot at the location of the common flexor muscle of the toes (flexor digitorum longus muscle).

According to one embodiment, the one-piece frame has a thickness of between about 0.5 mm and 7 mm. According to a preferred embodiment, the one-piece frame has a thickness of 1 mm.

According to one embodiment, the actuating portion is generally butterfly-shaped.

According to one embodiment, the actuating portion is arranged so as to extend at least to the lower third of the soleus muscle.

According to one embodiment, the actuating portion is arranged so as to extend substantially over the entire length of the soleus muscle.

According to one embodiment, the actuating portion is arranged so as to at least partly surround the calf.

According to one embodiment, the actuating portion is arranged so as to surround the calf and part of the back of the knee.

According to one embodiment, the frame is made of plastics, preferably of the thermoplastic elastomer type, more preferably of polyurethane. It is also optionally possible to have an embodiment in which the frame is made of silicone.

According to one embodiment, the contact zone comprises a lining made of polyurethane foam.

The invention also relates to a use of a device as described in the detailed description that follows to exert a massage pressure in a direction from the Achilles tendon towards the back of the knee during a walking movement of said human leg, in order to produce a self-massaging effect for peripheral lymphatic drainage on said selected area.

In addition, the invention relates to a shoe comprising a device as described in the detailed description that follows.

Further advantages and characteristics of the invention will become apparent from reading the detailed description that follows, and from the accompanying drawings, wherein:

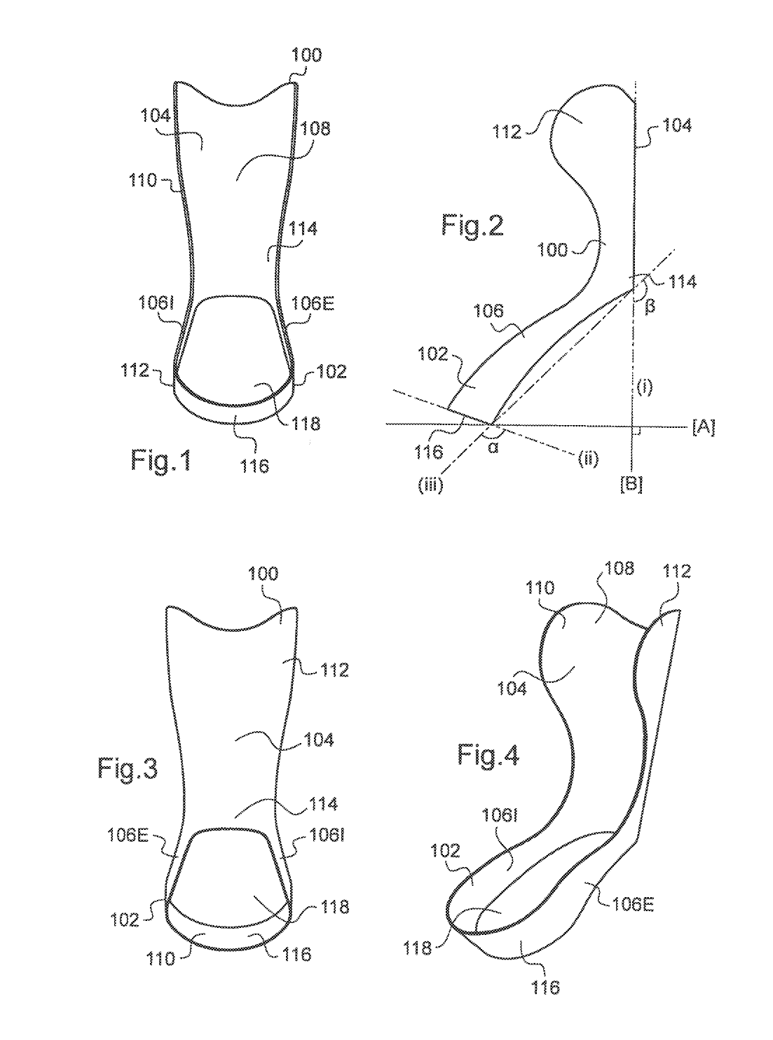

FIG. 1 shows a front view of a massage device according to a first embodiment of the invention,

FIG. 2 shows a profile view of a massage device according to the first embodiment of the invention,

FIG. 3 shows a rear view of a massage device according to the first embodiment of the invention,

FIG. 4 shows a perspective view (¾ anterior) of a massage device according to the first embodiment of the invention,

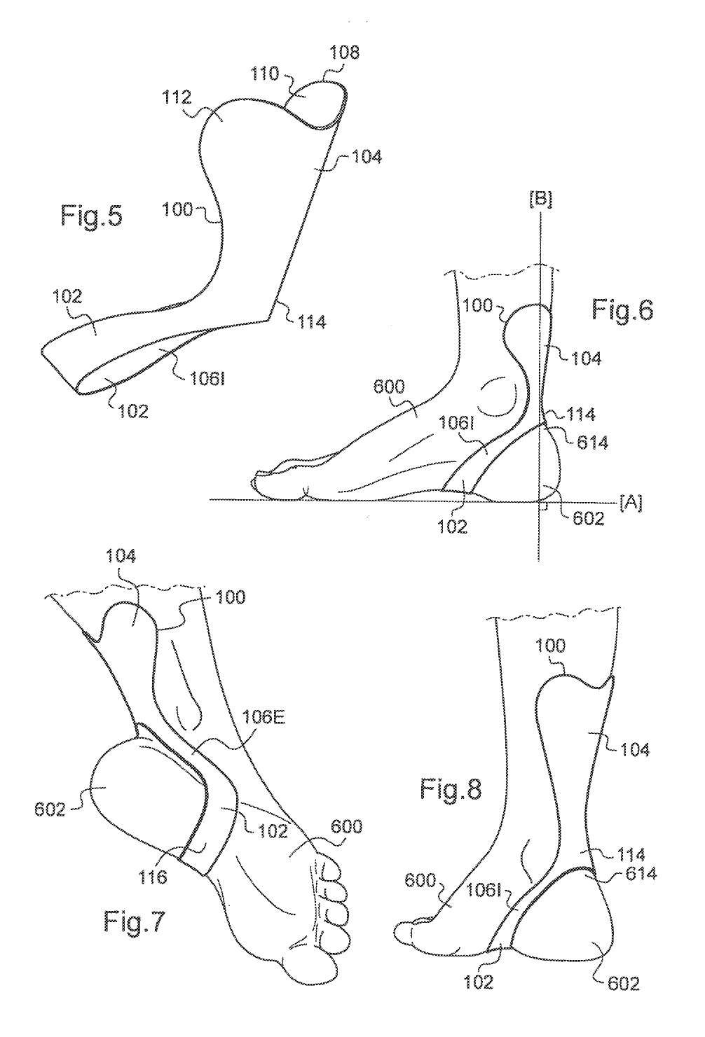

FIG. 5 shows a perspective view (¾ posterior) of a massage device according to the first embodiment of the invention,

FIG. 6 shows a profile view of the device in FIGS. 1 to 5 placed on a human right foot,

FIG. 7 shows a perspective view from below of the device in FIGS. 1 to 5 placed on a human right foot,

FIG. 8 shows a perspective view (¾ posterior) of the device in FIGS. 1 to 5 placed on a human right foot,

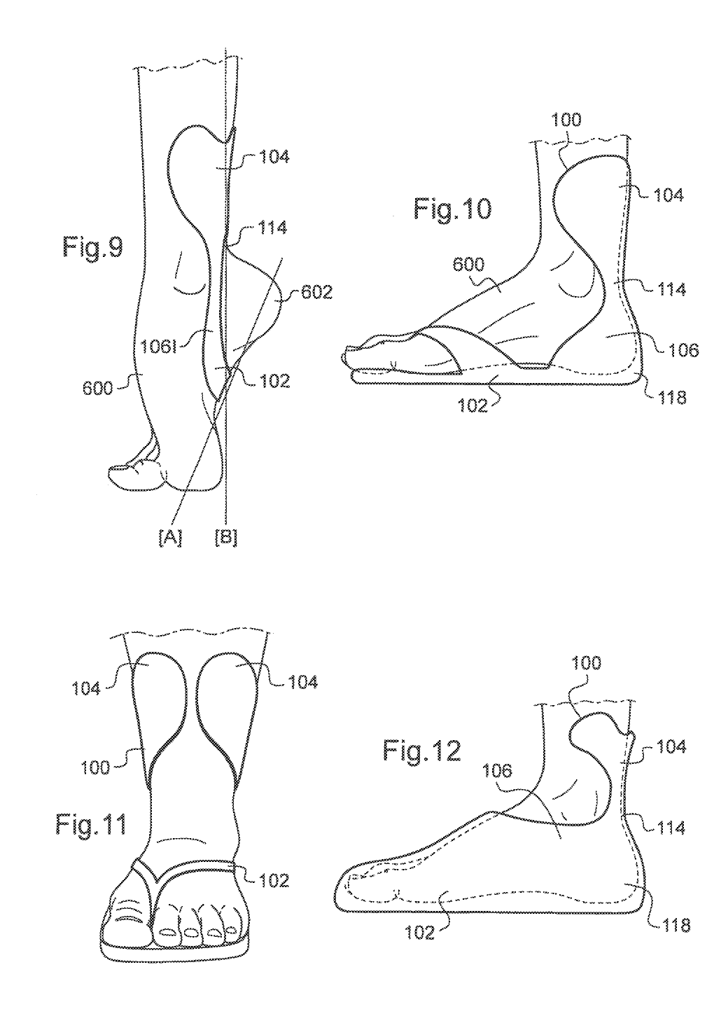

FIG. 9 shows a profile view of the device in FIGS. 1 to 5 placed on a human right foot, during a walking movement,

FIG. 10 shows a profile view of a device according to the invention according to another embodiment, placed on a human right foot,

FIG. 11 shows a front view of the device in FIG. 10 placed on a human right foot,

FIG. 12 shows a profile view according to another embodiment of the device according to the invention placed on a human right foot,

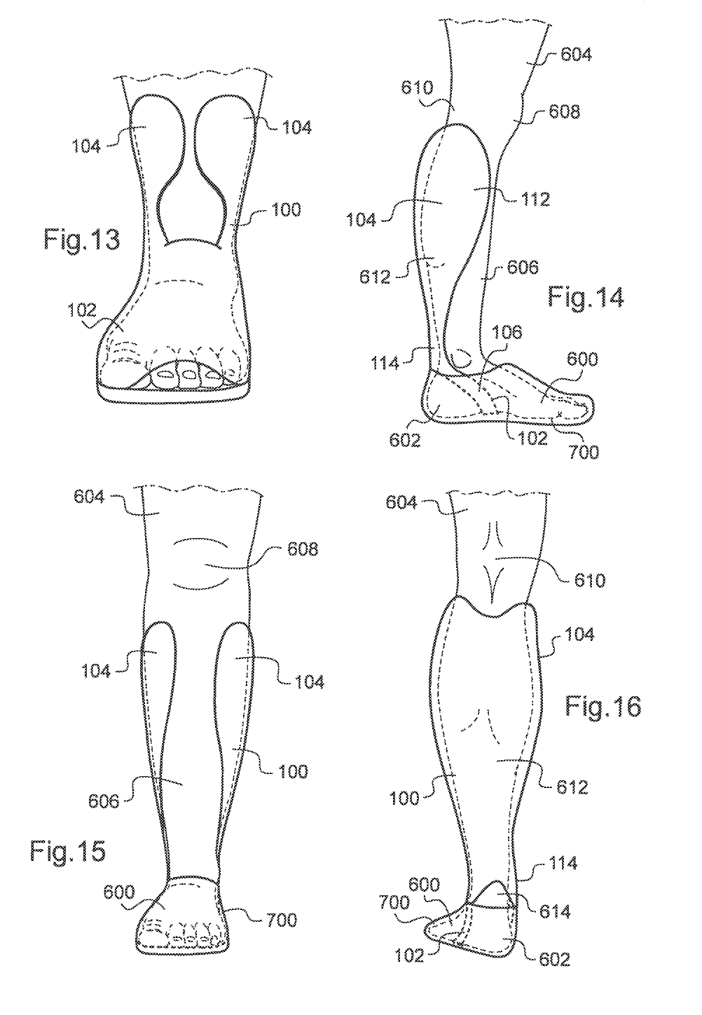

FIG. 13 shows a front view of the device in FIG. 12 placed on a human right foot,

FIG. 14 shows a profile view of a device according to another embodiment of the invention placed on a human left foot wearing a conventional walking shoe,

FIG. 15 shows a front view of the device in FIG. 14 placed on a human right foot, wearing a conventional walking shoe,

FIG. 16 shows a rear view of the device in FIG. 14 positioned on a human left foot wearing a conventional walking shoe.

The drawings and description that follow essentially contain elements of a specific nature. The drawings show, at least partly, aspects that are difficult to describe other than by drawing them. They form an integral part of the description and may therefore not only serve to assist with the understanding of the present invention but also contribute to its definition, in some instances.

FIGS. 1 to 5 show the device according to the invention in a first embodiment comprising a one-piece frame 100 made of an at least partially deformable material.

The one-piece frame 100 may be made of a material preferably of the thermoplastic elastomer type. One particularly suitable material is polyurethane, low density polyethylene (LDPE).

The one-piece frame 100 is designed to be placed on a human foot and is of a suitable thickness to allow it to be slipped onto a foot wearing a conventional walking shoe for everyday use.

A conventional walking shoe may vary greatly in its shape; in particular, it may or may not have a heel. Moreover, a conventional walking shoe may be open (like a sandal) or closed (like a trainer).

The frame may have a thickness of between about 0.5 mm and 7 mm, in particular. Preferably, the frame has a thickness of 1 mm.

The combination of material and thickness of the one-piece frame 100 will determine the service life of a device according to the invention. In fact, a one-piece frame 100 made of polyurethane with a thickness of 0.5 mm will not last as long as a one-piece frame 100 made of polyurethane with a thickness of 7 mm. According to a preferred embodiment of the invention, the one-piece frame 100 is made of polyurethane with a thickness of 1 mm.

The one-piece frame 100 comprises a supporting portion 102 which is arranged so as to at least partially surround a human foot over its entire length. In fact, according to the first embodiment described here, the supporting portion 102 comprises a lower part 116 designed to slip under the plantar arch in front of the heel of the foot.

The supporting portion 102 cooperates in the embodiment described with a recess 118 arranged in the one-piece frame 100. The recess 118 is arranged so as to receive the heel of the foot.

The one-piece frame 100 further comprises an actuating portion 104 of generally elongate shape extending substantially perpendicularly to said supporting portion 102. An intermediate portion 106 forms the connection between the supporting portion 102 and the actuating portion 104.

FIG. 2 shows a profile view of a device according to the first embodiment. The arrangement between the actuating portion 104, the intermediate portion 106 and the supporting portion 102 gives the device a profile that is generally “half-moon” shaped in appearance. This is chiefly due to the orthogonal relationship between the supporting portion 102 and the actuating portion 104, which is represented by the axes [A] and [B] to which the description will return later.

FIG. 2 also shows dotted lines (i), (ii) and (iii) which show respectively the extension of the one-piece frame over part of the supporting portion (i), the extension of the one-piece frame over part of the actuating portion (ii) and a junction line between a lower point of the supporting portion and a lower point of the actuating portion (iii). According to the embodiment shown here, two angles are distinguished, namely an angle α=115°, and an angle β=135°. In the embodiment in FIG. 2, the one-piece frame is made of polyurethane, and the angles α and β ensure cooperation between the supporting portion and the actuating portion in order to exert a pressure of about 15 mmHg on a selected part of the leg. It will be noted that the angles may vary, depending on the nature of the one-piece frame (notably as a function of the Shore A hardness of the material), to enable a pressure of about 15 mmHg to be exerted on the selected part of the leg.

According to the first embodiment described here, the intermediate portion 106 comprises an external intermediate portion 106E shaped so as to conform substantially to the foot at the location of the long fibular muscle. According to this embodiment, the intermediate portion 106 comprises an internal intermediate portion 106I shaped to conform substantially to the foot at the common flexor muscle of the toes. Thus, the device may be slipped over a patient's foot and fit the latter over at least part of its length.

The actuating portion 104 is designed in the general form of a ridge tile to fit at least part of the calf between the bottom of the Achilles tendon and the bottom of the thigh. By a general ridge tile shape is meant a cylinder that is cut along its main central axis.

As indicated above, the actuating portion 104 is shaped so as to fit at least part of a human leg, the part of the leg being located between the bottom of the Achilles tendon and the bottom of the thigh, and referred to here as the contact zone.

It should be understood that in the present description the term “thigh” denotes the part of a leg that is located above the back of the knee. Although anatomical/medical literature may refer to the back of the knee as being part of the thigh, the present description makes a clear distinction between the back of the knee and the thigh.

Moreover, the term back of the knee, in the present description, refers to the part located behind the knee, between the thigh and the calf, also known as the popliteal fossa.

The actuating portion 104 therefore comprises a contact zone 108 shaped to conform to the human leg. Generally, the contact zone 108 forms an integral part of the actuating portion 104.

The contact zone 108 is of a defined length to bear on a selected part of a human leg. The selected part in question is located between the bottom of the Achilles tendon and the bottom of the thigh of a human leg.

The contact zone 108 will have a massaging effect when the human leg performs a walking movement. In fact, the supporting portion 102 and the actuating portion 104 are arranged to cooperate, forming a lever 114 for the contact zone 108. Thus, when the patient performs a walking movement with his/her leg, the contact zone 108 has a massaging effect on the selected part against which it fits.

By a walking movement of a leg is meant, in the present description, the natural mode of locomotion of a human being. This mode of locomotion consists in a movement of transferring weight alternately to the legs, with the human being in the upright position, and having at least one point of contact with the ground.

A walking movement with reference to a leg comprises in particular the following phases:
a load-applying phase as the foot is placed on the ground, and
a phase of oscillation when the foot is off the ground.

The contact zone 108 may comprise a lining made of a foam-type material. The lining is then attached to the inner surface 110 of the one-piece frame 100, while the outer surface 112 does not have a lining.

In one embodiment, it may be envisaged that substantially the whole of the one-piece frame 100 is covered with a lining, notably for machining reasons.

The contact zone 108 may also be formed by a lining of polyurethane, LDPE, silicone, woven fabric, leather or by a pouch filled with fluid (air or gel in particular) or a combination of these.

The advantage of a lining is that it makes the contact between the selected part and the contact zone uniform, in order to enhance the massaging activity of the device, but also to increase the user comfort.

However, according to the embodiment described here, the one-piece frame 100 is made of a single material. Thus, there is no material difference between the contact zone 108, the actuating portion 104 or the supporting portion 102. In other words, the whole of the one-piece frame 100 is made of a selected material, such as polyurethane or LDPE.

According to the embodiment in FIGS. 1 to 5, the actuating portion 104 is formed in a generally butterfly shape so as to fit at least the lower third of the soleus muscle, by means of the contact zone 108.

According to another embodiment, the actuating portion 104 is shaped so as to extend substantially over the entire length of the soleus muscle.

According to yet another embodiment, the actuating portion 104 is shaped to as to at least partially surround the calf of the patient's leg. In this embodiment, the tibia is not in contact with the contact zone 108 (see below).

According to yet another embodiment, the actuating zone 104 and the contact zone 108 are shaped so as to extend over substantially the entire calf in order to at least partly surround a part of the back of the knee.

According to the invention, the actuating portion 104 comprising the contact zone 108 is shaped so as to exert a massaging pressure in a direction from the base of the Achilles tendon towards the back of the knee during a walking movement of said human leg.

When the device is placed on a patient's foot, the contact zone 108 makes it possible to create a self-massaging effect for peripheral lymphatic drainage over the selected area on which the contact zone 108 acts.

The self-massaging effect of the invention is associated with an anterior displacement of the actuating portion 104 during the placing of the foot on the ground during a walking movement (load-applying phase). This placing of the foot on the ground activates the lever 114 in an upward direction by means of the cooperation between the supporting portion 102 and the actuating portion 104.

Thus, a progressive disto-proximal pressure of at least 15 mmHg will be applied to the posterior-inferior third of the leg by the contact zone 108. This progressive disto-proximal pressure produces a reabsorption manoeuvre.

The self-massaging effect according to the invention is also associated with a posterior shift of the actuating portion 104 during the flexing of the foot before the heel meets the ground during a walking movement (oscillation phase). During this phase, the actuating portion 104 performs an oblique movement downwards and backwards. This is brought about by the activation of the lever 114 in a downward direction by means of the cooperation between the supporting portion 102 and the actuating portion 104. Thus, the contact zone 108 comes to bear on the posterior inferior third of the leg.

Thus, the actuating portion 104 carries out a posterior shift. During this posterior shift the retro-malleolar pressure is progressive in a proximo-distal direction, i.e. the opposite direction to the progressive disto-proximal pressure.

As a result of the activation of the lever 114, the actuating portion 104 thus moves in translation either in a generally upward direction, on the one hand, or in a generally downward direction, on the other hand, while actuating the contact zone 108 to massage the posterior inferior third of the leg periodically.

In the embodiment described, the activation of the lever 114 is ensured by the production of the one-piece frame 100 from deformable material. This arrangement of the one-piece frame 100 allows cooperation between the supporting portion 102 and the actuating portion 104. This cooperation leads to a plastic deformation (stretching, compression and twisting, in particular) of the intermediate portion 106 during a walking movement. The plastic deformation is at the origin of the operation of the lever 114. The lever 114 thus acts by plastic deformation on the contact zone 108.

FIGS. 6 to 9 show the device in FIGS. 1 to 5 fitted to a foot 600 of a human patient.

The internal intermediate portion 106I of the device conforms to the common flexor muscle of the toes. By contrast, the external intermediate portion 106E substantially conforms to the foot 600 at the long fibular muscle.

The supporting portion 102 passes underneath the plantar arch in front of the heel 602. The heel 602 is accommodated within the recess 118 of the device according to the invention. The one-piece frame 100, which is between about 0.5 mm and 7 mm thick and preferably 1 mm thick, may thus easily be worn when the patient is wearing conventional walking shoes.

By means of the actuating zone 104 comprising the contact zone 108, a selected part of the patient's leg is subjected to a massaging movement between the base of the Achilles tendon 614 and the bottom of the thigh.

FIG. 6 shows a foot 600 in the anatomical resting position, on which the device according to FIGS. 1 to 5 is fitted.

By the anatomical resting position is meant a bare foot placed on the ground and not wearing any kind of footwear to modify its natural configuration.

FIG. 6 shows a foot in the anatomical resting position, by way of example. However, in general, the term “resting” in the present description means a foot that may or may not be wearing some kind of footwear (especially a conventional walking shoe) placed on the ground. Equally, it should be noted that during a walking movement a foot will at a given moment adopt a position similar to that of the resting foot.

When the foot 600 is not engaged in a walking movement but at rest, the lever 114 is inactive and the supporting portion 102 is substantially perpendicular to the actuating portion 104. This is indicated by the axes [A] and [B] in FIG. 6.

FIG. 9 shows the arrangement of the device during a walking movement (more precisely at the end of the load-applying phase, just before the oscillation phase). The lever 114 is active in forming a change of angle of the axes [A] and [B] when the patient is putting his weight on his toes.

When the foot 600 performs a walking movement as in FIG. 9, the angle of about 90° between the axes [A] and [B] is modified and forms an angle that is about +13° greater, compared with the resting position in FIG. 6.

During a walking movement, two extreme situations arise. In the first, the toes are positioned upwards just before the heel strikes the ground before the foot is placed on the ground, and in the second, the toes are positioned downwards just before the foot leaves the ground during the walking movement. Taking as the reference the anatomical resting position of the foot in FIG. 6, the angle of 90° of the axes [A] and [B] is modified:
in the position with the toes upwards: −7° (i.e. 83°);
in the position with the toes downwards: +13° (i.e. 103°).

To absorb the stresses resulting from the change of angle the material is preferably made of low density polyethylene or polyurethane.

Table 1 shows characteristics of low density polyethylene adapted to produce the one-piece frame 100.

TABLE 1
Physical characteristics of LDPE

| Properties | Value (unit) |
|---|---|
| Bulk density | 0.917 (g/cm³) |
| Young's modulus | 237 (MPa) (150-300 MPa) |
| Poisson's ratio | 0.45 |
| Yield stress (MPa) | 10-13 MPa |
| Yield strain (%) | 32.5 (%) |
| Breaking strain | 319 (%) |

It should be understood that the characteristics of low density polyethylene are given here purely by way of example and are in no way restrictive with regard to the materials used for the invention and more specifically the one-piece frame 100. In fact, as mentioned previously, materials such as polyurethane or LDPE are suitable for use according to the invention.

FIGS. 6 to 9 show the actuating portion 104 fitting the foot over the contact zone 108. As mentioned previously, the contact zone 108 may be made of a foam-type material, for example. The fixing of the foam-type material may be achieved using a velvet material in conjunction with hooks (touch-and-close material) or by directly adhering the foam-type material to the actuating portion 104. A foam-type material chiefly has the effect of substantially fitting to the selected area on which the contact zone 108 acts, to increase the effect of the device on the selected area but also to ensure comfort for the user.

However, a lining is not essential for carrying out the invention, provided that a contact zone 108 is established between the actuating zone 104 and the selected area of the patient's leg.

FIGS. 10 and 11 show a device according to the invention in another embodiment, namely in a form that is generally of the sandal type. The supporting portion 102 comprises a section passing under the plantar arch in front of the heel, as well as a part extending over the foot to surround, from above, firstly the big toe, and secondly the other four toes.

The recess 118 is made as a pocket that accommodates the patient's heel 602. The lever 114 is activated in the same way as in the embodiment of the device according to the invention shown in FIGS. 1 to 9, namely by cooperation between the supporting portion 102 and the actuating portion 104. Cooperation is ensured in particular by the intermediate portion 106.

FIGS. 12 and 13 show another embodiment of the device according to the invention. The supporting portion 102 comprises a section that passes below the plantar arch but also a slipper-shaped section which extends over the top of the foot to hold the latter. The cooperation between the actuating portion 104 and the supporting portion 102 is provided by the lever 114. The intermediate portion 106 provides the junction between the supporting portion 102 and the actuating portion 104 and cooperation between them.

FIGS. 14 to 16 show the device according to the invention in an embodiment comprising an actuating portion 104 at least partly surrounding the calf 612 of a patient's leg 604. In fact, the actuating portion 104 is generally elongate in shape and generally butterfly-shaped in appearance and extends from the bottom of the Achilles tendon 614 to the base of the back of the knee 610. The tibia 606 and knee (608) are not in contact with the contact zone 108.

In the embodiment in FIGS. 14 to 16, the device according to the invention is fitted to a human foot inside a conventional walking shoe 700.

In an embodiment that is not specifically shown in the drawings, the supporting portion 102 may comprise an anchoring portion which has fixing means designed to be fixed inside a shoe 700. This may comprise a touch-and-close material or a system of buttons (especially press-studs).

The actuating portion 104 and more precisely the contact zone 108 have a mechanical effect which is activated while walking. It is, in particular, a periodic pressure movement for stimulating venous and lymphatic circulation in the calf 612, or more precisely between a selected part located between the bottom of the Achilles tendon and the bottom of the thigh.

The butterfly shape of the one-piece frame 100 of the embodiment reproduces the conditions of peripheral lymphatic drainage.

The materials, such as LDPE or polyurethane, for example, enable the device according to the invention to adapt to and fit the shape of a patient's leg (including the foot).

According to the embodiments described, the actuating portion 104 and the contact zone 108 work together to ensure good peripheral lymphatic drainage. In fact, it is advantageous to provide a contact zone 108 which homogeneously fits the selected area to exert periodic pressure. As mentioned previously, the material may be polyurethane, a polyurethane foam, silicone, or leather, woven fabric, pouches filled with fluid (gel or air) or any desired combination of these.

According to one embodiment, the device is arranged so as to exert a pressure of about 15 mmHg on both sides, either side of the Achilles tendon.

1. Massage device for the human leg, characterised in that it comprises a one-piece frame (100) made of an at least partly deformable material having a supporting portion (102) arranged to at least partly surround a foot along its length and a generally elongate actuating portion (104) extending substantially perpendicular to said supporting portion (102) and connected thereto by an intermediate portion (106), the actuating portion (104) comprising a contact zone (108) shaped so as to conform to the human leg and having a defined length in order to be supported on a selected part thereof located between the bottom of the Achilles tendon and the bottom of the thigh, so as to provide a self-massaging effect during a walking movement of the human leg.

2. Device according to claim 1, wherein the supporting portion (102) and the actuating portion (104) are arranged to cooperate, forming a lever (114) for the contact zone (108) during said walking movement of the human leg.

3. Device according to claim 1, wherein the supporting portion (102) comprises an anchoring portion comprising fixing means arranged to be fixed inside a shoe.

4. Device according to claim 1, wherein the supporting portion (102) comprises a lower portion arranged to pass under the plantar arch in front of the heel of the foot and a recess (118) arranged so as to accommodate the heel of the foot.

5. Device according to claim 1, wherein the intermediate portion (106) comprises an external intermediate portion (106E) shaped so as to conform substantially to the foot at the location of the long fibular muscle (fibularis longus muscle) and an internal intermediate portion (106I) shaped so as to conform substantially to the foot at the location of the common flexor muscle of the toes (flexor digitorum longus muscle).

6. Device according to claim 1, wherein the frame (100) has a thickness of between about 0.5 mm and 7 mm, and preferably 1 mm.

7. Device according to claim 1, wherein the actuating portion (104) is generally butterfly-shaped.

8. Device according to claim 1, wherein the actuating portion (104) is shaped so as to extend at least to the lower third of the soleus muscle.

9. Device according to claim 1, wherein the actuating portion (104) is shaped so as to extend substantially over the entire length of the soleus muscle.

10. Device according to claim 1, wherein the actuating portion (104) is shaped so as to at least partly surround the calf.

11. Device according to claim 1, wherein the actuating portion (104) is shaped so as to surround the calf and part of the back of the knee.

12. Device according to claim 1, wherein the frame (100) is made of plastics, preferably of the thermoplastic elastomer type, more preferably polyurethane.

13. Device according to claim 1, wherein the contact zone comprises a lining.

14. Shoe comprising a device according to claim 1.

15. Device according to claim 2, wherein the supporting portion (102) comprises an anchoring portion comprising fixing means arranged to be fixed inside a shoe.
